(19) United States
(12) Patent Application Publication
(10) Pub. No.: US 2025/0238877 A1
(43) Pub. Date: Jul. 24, 2025

(54) METHOD FOR ASSESSING RISK OF TOXIN FORMATION IN CROPS

(71) Applicant: Collin MAUNE, Washington, MO (US)

(72) Inventor: Collin MAUNE, Washington, MO (US)

(21) Appl. No.: 19/027,266

(22) Filed: Jan. 17, 2025

Related U.S. Application Data
(60) Provisional application No. 63/622,802, filed on Jan. 19, 2024.

(51) Int. Cl. G06Q 50/02; A01G 7/00; G06Q 10/0635

(52) U.S. Cl. CPC G06Q 50/02; A01G 7/00; G06Q 10/0635

(57) ABSTRACT

A method for field level data to be gathered during planting, growing and harvesting crops, and then comparing such data with information relevant to toxin formations in specific regions, conditions, irrigation situations, planting times etc. to determine crop value and damage potential at the time of harvest. This derived information benefits the producer in making real time decisions on how to harvest, and how to potentially mitigate the losses toxins cause to each producer's crop.

### RELATED APPLICATION

The present non-provisional patent application claims priority benefit of an earlier-filed provisional patent application of the same title, Ser. No. 63/622,802, filed Jan. 19, 2024. The identified earlier-filed application is hereby incorporated by reference into the present application.

### FIELD OF THE INVENTION

The present invention relates to determining risks to crops during the planting, growing and harvesting of crops. In particular, the invention relates to determining the risks to crops caused by exposure to mycotoxin formation. More specifically, the invention relates to the use and assessment of data relevant to the crop seed, potential mycotoxin exposure and environmental conditions in determining risk to a crop during a growing season.

### BACKGROUND OF THE INVENTION

During the planting, growing and harvesting of crops in a given season, exposure to mycotoxins can cause a substantial deleterious effect on the crops. In particular, the presence of mycotoxins can harm the plant leading to a reduction in the yield of the crop. The adverse consequences of a lower yield affect not only the farmer/grower, but also to every participant in the growing, storage and distribution chain who financially depend on a robust crop. The presence of mycotoxins can also present health hazards in the handling of affected crop and to animals who are fed the crop.

An embodiment of the invention provides a method for field level data to be gathered during planting, growing and harvesting crops, and then comparing such data with information relevant to toxin formations in specific regions, conditions, irrigation situations, planting times etc. to determine crop value and damage potential at the time of harvest. This derived information benefits the producer in making real time decisions on how to harvest, and how to potentially mitigate the losses toxins cause to each producer's crop. With the platform and the data that can be generated from the process, major grain movement in the US and Canada can be positively impacted. Risks to the crop can be lowered and the final grain products will be more completely defined and better utilized by the processors and end users.

Mycotoxins cause millions of dollars of agriculture losses each year. Besides the economic losses caused by toxins, there can exist adverse health effects, including death to both humans and animals. By having options for producers to have knowledge of toxin formation probabilities in crops prior to harvest at a field level, risk management and harvest techniques can be delivered to harvesting equipment at specific field levels.

There is a need for a predictor model that can provide advance and real-time information for a producer/grower to determine the potential risk to a particular crop during the planting, growing and harvesting phases of crop growth. Such information would enable the producer/grower to better address the risk and provide strategies to maximize or salvage the crop yield armed with such information. There exist predictor models that have been researched and developed but are regional and large scale and do not provide the specific data at the granular field level. Predictors have used a range of data for regional areas but are mainly used for application of fungicide and to address potential disease risk on a widespread scale.

### BRIEF SUMMARY OF THE INVENTION

An embodiment of the invention provides for a method for gathering and inputting granular real-time field data such as soil conditions, planting dates and crop characteristics to be utilized in a platform that can be delivered to harvesting equipment, cell phones, and computers. This has the capability to be cloud based and can be made available to producers globally. This platform will notify the growers/producers of risk from mycotoxin formation, suggest mitigation techniques applicable during harvest, and provide confirmation of data. By utilizing this platform at the field level that is specific to a particular planted crop, each producer can determine field by field risks and mitigation or best use of the harvested product coming from the specific field. This also enables the manufacturers of this type of equipment to better support producers in real time.

### BRIEF DESCRIPTION OF THE DRAWINGS

The present disclosed subject matter is described herein with reference to the following drawing figures, with greater emphasis being placed on clarity rather than scale:

FIG. 1 shows a sample display of a report summarizing the level of risk of toxin present in selected fields in which crops are planted.

FIG. 2 shows a sample display of a toxin testing summary showing the degree of risk of mycotoxin contamination for a selected field.

### DETAILED DESCRIPTION OF THE INVENTION

Users enter their field data (Planting Data, Hybrid, Location) into the Mycotoxin Prediction Software customer portal. Through API connections (Application Programming Interfaces), the field data that the user enters is brought into the Mycotoxin Prediction Software Data Factories. With the field data in the Mycotoxin Prediction Software Data Factories, daily weather datapoints for that specific location are gathered using API connections with public weather sources (IBM Weather, Weather API). Over the course of the growing season, the weather dataset gets analyzed daily for weather conditions that create environments for Mycotoxins. Plants are susceptible to the formation of molds and increased risk of mycotoxins occurs at anthesis or flowering. Anthesis in corn occurs when the silks and tassels become visible. Pollen is released from the tassels to land on the corn silks. This pollinates each kernel of corn on the ear. During this critical time, weather and soil conditions are a critical part of the success of the crop. Corn maturation varies for different seed varieties. Each hybrid has a published date to maturation and resources can be consulted for this information. The hybrid maturation timeframe effects the time to anthesis. Additionally, the time that planting takes place directly effects the time the anthesis will occur. Later planting leads to later flowering, which consequently generally means flowering would occur at a hotter and sometimes drier part of the growing season. Earlier planting can lead to anthesis occurring during cooler conditions, a wetter spring and early summer rains. Each of these conditions have direct potential effects on the type of toxins found in the products.

For wheat, the situation is slightly different as a large portion of the wheat is planted (drilled) in the fall, it grows over the winter, and is harvested in the late spring to early summer the following year. The anthesis occurs during the late spring. This crop, as well, is affected by the weather and humidity during the time of anthesis. Because of variable conditions, crops can turn from good to very poor in a short amount of time.

Different weather conditions create environments that elevate the risk for different toxins. Soil moisture in both the topsoil and subsoil affects the molds that will thrive and grow. Additionally, topsoil and subsoil moisture during growing season is an indicator of the potential for toxins. Humidity that forms around the stalks, or wheat heads is a source of moisture that can increase mold infections, such as from fusarium. This humidity is affected by weather events, but can also be affected from evaporation of the moisture in the fields where the crops are planted.

Per Iowa State Crop Extension, “a mycotoxin called Aflatoxin can occur with temperatures from 55-104° F. (optimum 81-86° F.), and 17-18 percent and higher moisture content”. While other Mycotoxins, zearalenone and deoxynivalenol, can occur with moderate temperatures and high humidity, per Penn State. As the fields get closer to being harvested, the Mycotoxin Prediction Software then generates a risk assessment for specific toxins based on the analyzed weather. The risk assessment for these toxins is based on thousands of historical and current samples, that included the field data parameters. These samples are tested by an accredited Mycotoxin Laboratory and are tested for Mycotoxins using a Resonon Pika Hyperspectral Camera that is integrated as part of the Mycotoxin Software. The results are then uploaded into the Mycotoxin Prediction Software to continually refine the risk assessment, along with the comparative testing between the two testing methods (both wet chemistry and Hyperspectral testing). This risk assessment report is then sent back to the user through API connections/or the Mycotoxin Prediction customer portal.

Parameters that are monitored and measured in the implementation of the invention include: the planting dates, the particular hybrids planted, the condition of the top soil and subsoil moistures, and soil mold counts. Other factors relating to the hybrid include protein, fat, fiber etc. These results are expressed to the producer in everything from % to CFU/g to ppb. These results will be represented in numerical format but with graphics or ranges to serve as references as well. These will be easy to understand and practical results representations to aid the producers in making sound decisions to manage their crop quality. In addition to these parameters other items such as Anthesis silk interval and pollen shed data can be captured to add more depth to the crop in specific fields.

Data to be used in determining the risk is gathered and calculated. Throughout the growing season, the data parameters include: weather data, soil data, plant maturation data, data relating to crop, fungicide and efficiency, current prescriptions for fungal applications, relative humidity in the field, atmospheric moisture, vapor pressure deficit, dew point, forecasts indicating stability of temperature 20 days prior to anthesis, barometric pressure, ground temperature and other field data specific to the field in which the crop is planted. These data parameters are gathered to offer predictive advice on the crop while it is still in the growing stage. This allows the producer to do some preplanning and monitoring. Much of the data can be downloaded from the cloud-based system. As the growing season continues, additional data can be gathered and uploaded to be compiled for calculating additional risk. At harvest, a risk factor is presented from the assessment of the data.

Reports are generated based on the planting time and growing conditions. A risk assessment will be presented from the data analyzed by the program. This report will weigh the potential for mycotoxins in the specific crop being harvested. Reports will have background on the toxin potential, options for different avenues for use should the contamination be high, levels to be aware of, regulations both in the US and other countries, safety suggestions for the harvest etc. This report will be as robust as possible giving information not only about the toxins suspected of being present, but also about the potential for things like high incidence-low incidence of contamination, all the way through low incidence-high contamination.

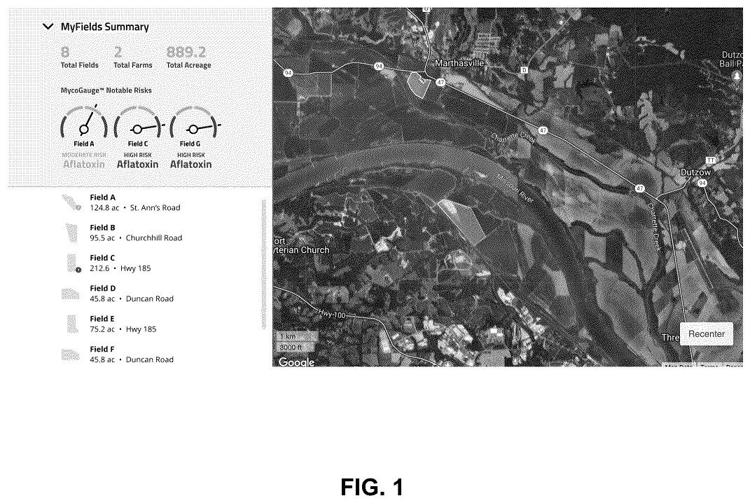

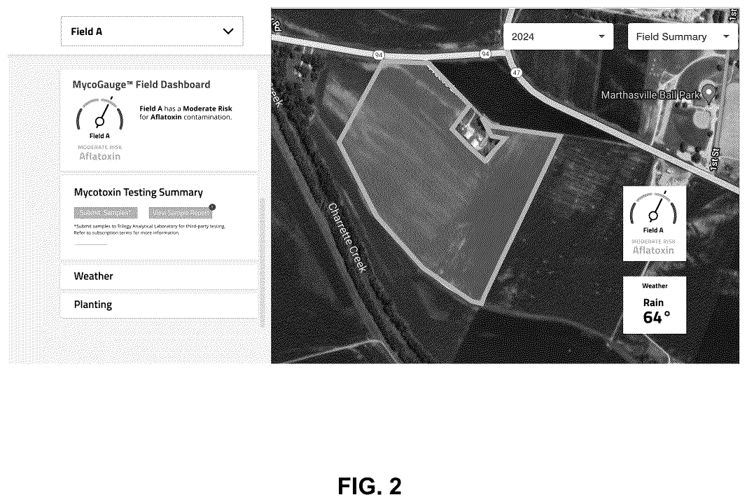

When grain producers/farmers plant a field, they can enter their field data into different digital platforms. Examples are, John Deere Operations, Case FieldOPS, FieldView and many other platforms. Through API connections (Application Programming Interfaces), the field data that the user enters on their digital platform is brought into the Mycotoxin Prediction datastore. With the field data, in the Mycotoxin Prediction datastore, daily weather datapoints for that specific location are gathered in the datastore. Over the course of the growing season, the weather dataset gets analyzed daily. As the fields get closer to being harvested, the Mycotoxin Prediction Datastore then generates a risk assessment for specific toxins based on the analyzed weather. This risk assessment report is then sent back to the user through API connections onto their digital platform that they are using. FIGS. 1 and 2 provide examples of displays of the risk assessment reports generated.

As an example, a farmer using the digital platform, FieldView, enters the hybrid, plant date and field location from the field they are planting. That field data is then sent through an API (Application Programming Interface) connection to the Mycotoxin Prediction software customer portal. Over the course of the growing season the Mycotoxin Prediction software gathers daily weather data for that specific field using public weather sources (such as IBM Weather, Weather API). the weather dataset gets analyzed daily for weather conditions that create environments for Mycotoxins. Different weather conditions create environments that elevate the risk for different toxins. Per Iowa State Crop Extension, “a mycotoxin called Aflatoxin can occur with temperatures from 55-104° F. (optimum 81-86° F.), and 17-18 percent and higher moisture content”. Other Mycotoxins, zearalenone and deoxynivalenol, can occur with moderate temperatures and high humidity, per Penn State.

As the field gets closer to harvest, the Mycotoxin Prediction software generates a risk assessment of the field based on the field data the farmer entered, along with the weather data for that field. The risk assessment for these toxins is based on thousands of historical and current samples, that included the field data parameters. These samples are tested by an accredited Mycotoxin Laboratory and are tested for Mycotoxins using a Resonon Pika Hyperspectral Camera that is integrated as part of the Mycotoxin Software. The results are then uploaded into the Mycotoxin Prediction Software to continually refine the risk assessment, along with the comparative testing between the two testing methods (both wet chemistry and Hyperspectral testing). The risk assessment is then sent to the farmer/user using an API connection to the Mycotoxin Prediction customer portal (digital platform FieldView).

In implementing toxin mitigation for a particular crop, a field scouting protocol will be downloaded just prior to harvest. The protocol explains the process of collecting data on fungal growth in the field. This may consist of pulling the corn husks down at several random areas in the field and observing the fungal growth and insect damage. When toxins are present or suspected of being present, several things can be implemented at harvest. For example, combine settings can be adjusted to minimize the damaged and broken kernels, as well as helping reduce the number of kernels that are actively infected with mold. These kernels are where a large portion of the toxins are concentrated. In years that are not considered toxin years, harvesting is about garnering as much grain from the harvest process so as not to lose any yield. This is somewhat counterintuitive that by reducing the amount of harvest that is collected, the value of the grain can go up. Adjusting the cylinder speed will help minimize any more damage or breaking more kernels. Broken or insect damaged kernels open food sources for the molds, thus increasing the potential for additional mold growth during the storage time after harvest. Adjusting the cylinder speed can reduce the amount of time each harvested kernel meets the moving parts on the combine. Additionally, increasing the fan speed on the combine can blow out the lighted mold damaged kernels. And finally, when mycotoxins are suspected, it is imperative to reduce the time from harvest to complete dry-down. Corn should always be stored at less than 14% moisture. Aeration can be applied to keep the moisture from building up in the storage vessel. When possible, grain storage temperatures of 34° F. to 39° F. should also be maintained to minimize additional toxin formation.

There are multiple industries that would benefit from this invention. Producers that will ultimately sell their harvest to companies or co-ops will be able to adjust harvest procedures and mitigate losses prior to grain delivery. Grain facilities will have better product, specifically on crisis years where mycotoxins are widely prevalent. This will increase the value of their products and ensure delivery of acceptable products to their business partners. Insurance agencies such as the ACSC program utilized by the government can teach and provide consulting on best practices for their clients in specific areas. This improves the local economies in multiple ways. It increases the farmers ability to have less losses in a toxin year, it enables farm integrated operators to reduce the risk of animal effects, milk production losses and overall “poor doers” that cost time and money.

This could also have a profound effect on the supply chain for corn and wheat. By minimizing the risk, not just in the US but globally, overall human consumption products will be improved. Toxins are typically problematic somewhere in the world—every year. The widely variable extreme weather events have increased the toxin problems worldwide. This means in many years more toxins are in the crops at levels that are difficult to effectively put into the food chain for animals and humans. Any company that is involved in the movement of grains will benefit from this platform and subsequent knowledge. Large grain handlers, feed producers for everything from large animals to pets will have the potential to benefit.

What is claimed is:

1. A method for assessing a risk of mycotoxin in a crop harvest from a selected field comprising the steps of:
a. Selecting a field in which a crop is to be planted;
b. Gathering data from the selected field affecting growth of the crop, the data comprising information on soil composition and moisture content in the selected field;
c. Planting the crop seed in the selected field and gathering data from the planting including characteristics of the crop seed, local weather conditions and moisture content of the soil composition;
d. Monitoring the data and changes in the weather conditions and moisture content as the crop grows;
e. Comparing the gathered data with known factors affecting mycotoxin growth in creating a report;
f. Using the report to forecast a risk of mycotoxin contamination of crops harvested from the selected field.

2. The method of claim 1 in which data from the report is assessed to adjust crop harvesting methods to minimize presence of toxin contaminated grain harvested from the crop.
